(19) United States
(12) Patent Application Publication
(10) Pub. No.: US 2015/0048609 A1
(43) Pub. Date: Feb. 19, 2015

(54) Resettable Load-Limiting Adaptive Seatbelt Apparatus

(71) Applicant: Michael R. Schramm, Perry, UT (US)

(72) Inventor: Michael R. Schramm, Perry, UT (US)

(21) Appl. No.: 13/726,460

(22) Filed: Dec. 24, 2012

Related U.S. Application Data
(63) Continuation-in-part of application No. 12/623,602, filed on Nov. 23, 2009, now Pat. No. 8,336,663.
(60) Provisional application No. 61/117,565, filed on Dec. 31, 2008.
(60) Provisional application No. 61/141,763, filed on Dec. 31, 2008.

(51) Int. Cl. B60R 22/32

(52) U.S. Cl. CPC B60R 22/32
USPC 280/806

(57) ABSTRACT

The present invention is a resettable load-limiting adaptive seatbelt apparatus having the means to readily allow release or disengagement of the seatbelt apparatus at a predetermined load in response to a first situation, and having the means to prevent release or disengagement of the seatbelt apparatus at the predetermined load in response to a second situation, and yet having the means to allow limited non-disengagement load-limiting payout of the seatbelt apparatus at a variable predetermined load in response to a third situation.

### CROSS REFERENCE TO RELATED APPLICATION

This nonprovisional utility application is a continuation-in-part of and claims the benefit under 35 USC §120 to co-pending U.S. application Ser. No. 12/623,602 filed Nov. 23, 2009, which is a nonprovisional application of and claims the benefit under 35 USC §119(e) of U.S. Provisional Patent Application No. 61/117,565, filed Nov. 24, 2008, and of U.S. Provisional Patent Application No. 61/141,763, filed Dec. 31, 2008, all of which are incorporated herein in their entirety by this reference.

### FIELD OF THE INVENTION

The present invention relates to seatbelts, and more especially to seatbelts having a low load complete release mode for emergency release of the seatbelt and having a high load limited release mode for limiting the load applied to a belted occupant in a crash mode.

### BACKGROUND OF THE INVENTION

Seatbelts are well known in the vehicular safety industry and have had broad usage for many years in saving lives and reducing injury that might have otherwise occurred to accident victims. However, in spite of the many advantages seatbelts provide, and in spite of laws passed by many states within the United States, there remains a significant portion of the motoring public that choose not to use seatbelts. Reasons for such intentional non-use of seatbelts include for instance concerns regarding extrication (especially self-extrication) from a post-accident vehicle, especially when such post-accident vehicle comes to rest in a body of water such as a river or a lake and a vehicle occupant is unable to reach or otherwise release a seatbelt. Recently, an incident where a seatbelt became entangled around a child's neck was known to have occurred (see “Child Revived After Being Strangled by Seat Belt” article included herein as appendix C). In the incident, the seatbelt was reported to have become tight enough that the panicking mother was unable to depress the eject button sufficient to release the seatbelt. In the incident, the responding police officer had to sever the seatbelt to extricate the child. Certain police departments, including the one identified in the incident have required the carrying of a knife for use in cutting a seatbelt to release an occupant in an emergency situation. Further, at least three other similar incidents are reported to have occurred in the last decade (see “Boy, 5, Riding With Family on I-95 Is Critically Injured by Seat Belt” article included herein as appendix D). Although release of a properly functioning seatbelt typically requires relatively little time, an additional reason for intentional non-use of seatbelts includes the concern, particularly for law enforcement officers, of not being able to exit a vehicle quickly enough in emergency situations such as when needing to exit a vehicle and draw a weapon in a threatening or potentially threatening situation when time is of the essence and the time required to release a seatbelt may result in increased danger or harm to the officer (see the Nov. 23, 2008 Standard Examiner articles regarding law enforcement concerns regarding seatbelts, included herein as appendices A and B). Thus many law enforcement officers are not taking advantage of the benefits of seatbelts due to the disadvantages of the current seatbelt state of the art. Some efforts to solve the above described problems have been attempted. Such efforts include the concepts disclosed in the following US patents and applications which are incorporated herein by reference in their entirety: U.S. Pat. No. 4,083,581 to Clifford entitled “Emergency Release Systems”, U.S. Pat. No. 4,245,856 to Ziv entitled “Emergency Release for Passive Seat Belt Systems”, U.S. Pat. No. 4,265,415 to Harrell et al entitled “Emergency Release Device for Seat Belt Retractor”, U.S. Pat. No. 4,296,942 to Clifford entitled “Emergency Release Systems”, U.S. Pat. No. 4,374,594 to Kawaharazaki entitled “Emergency Buckle Device”, U.S. Pat. No. 4,398,750 to Thomas entitled “Emergency Release Mechanism for Passive Seat Belt Systems”, U.S. Pat. No. 4,773,613 to Kawai et al entitled “Emergency Lock Retractor Equipped with Webbing clamp Device”, U.S. Pat. No. 4,815,177 to MacKew entitled “Automatic Time-Delayed Release Buckle”, U.S. Pat. No. 5,121,527 to Righi entitled “Automatic Release Device for Seat Belts on Motor-Vehicles or the Like”, U.S. Pat. No. 6,123,166 to Verellen entitled “Release Apparatus for a Seat Belt Buckle”, U.S. Pat. No. 7,178,208 to Bentsen et al entitled “Seat Belt with Magnetically Seated Buckle and Automatic Release”, U.S. Pat. No. 7,201,248 to Shaw entitled “User-Controlled Vehicle Safety Belt Release System”, 2007/0006431 to Bentsen et al entitled “Seat Belt with Magnetically Seated Buckle and Automatic Release”, 2007/0204442 to Falb et al entitled “Seat Belt Buckle”, 2008/0054615 to Coultrup entitled “Tactical Seatbelt Quick Release System”, and 2009/0139069 to Thomas entitled “Automatic Seat Belt Release System”.

Further, so-called “Load-Limiting” seatbelts, which attenuate seatbelt loading that would otherwise be applied to a belted occupant in a crash scenario are well known in the vehicular safety industry and have had broad usage for many years in saving lives and reducing injury by reducing the peak load that is applied to a belted occupant by a seatbelt. Many such load-limiting seatbelts are not resettable and most such load-limiting seatbelts function by means of 1) allowing a deformable torsion member to permanently deform, 2) by performing work in a hydraulic motor, or 3) by allowing the seatbelt to stretch, so as to dissipate energy. Examples of such load-limiting seatbelt type seatbelts are disclosed in the following US patents and applications which are incorporated herein by reference in their entirety: 2012/0193462 to Hiramtsu et al. entitled “Method of Limiting a Load Applied on a Seat Belt in an Emergency”, U.S. Pat. No. 6,695,243 to Specht entitled “Seat Belt Retractor with Hydraulic Load Limiting”, and U.S. Pat. No. 8,201,850 to Browne et al. entitled “Adjustable Belt Tensioning Utilizing Active Material Actuation”.

### SUMMARY OF THE INVENTION

The invention disclosed herein is a resettable load-limiting adaptive seatbelt apparatus (RLLASA) or apparatus having the means to readily allow release or disengagement of the seatbelt apparatus at a predetermined load in response to a first situation, and having the means to prevent release or disengagement of the seatbelt apparatus at the predetermined load in response to a second situation, and yet having the means to allow limited non-disengagement load-limiting payout (limited slip) of the seatbelt apparatus at a variable predetermined load in response to a third situation. In contrast to an apparatus that completely releases a seatbelt in response to an intentional release actuation or in response to an emergency situation, the RLLASA has an advantage of not releasing the seatbelt, but rather rending the seatbelt easily releasable or extractable, and thus avoids the nuisance of the requirement to re-buckle the seatbelt in a false-positive emergency or non-emergency situations (i.e. a situation when seatbelt release is not desirable). Further, there is no damage to the RLLASA if the RLLASA is partially (load-limitingly) released or completely released (disengaged), or in other words, the RLLASA is completely reusable.

### DESCRIPTION OF DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a trimetric view of a first embodiment of the RLLASA and includes the display of a portion of the interior of a vehicle in which the apparatus is shown installed;

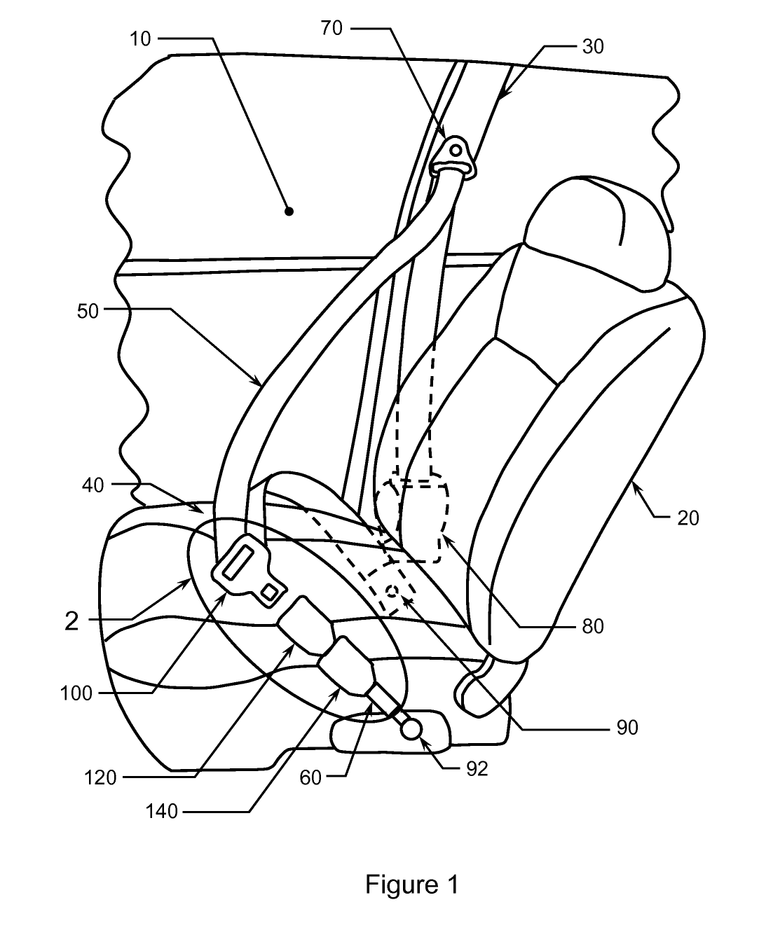

FIG. 2 is an enlarged alternate trimetric view of the buckle portions of the RLLASA shown in FIG. 1;

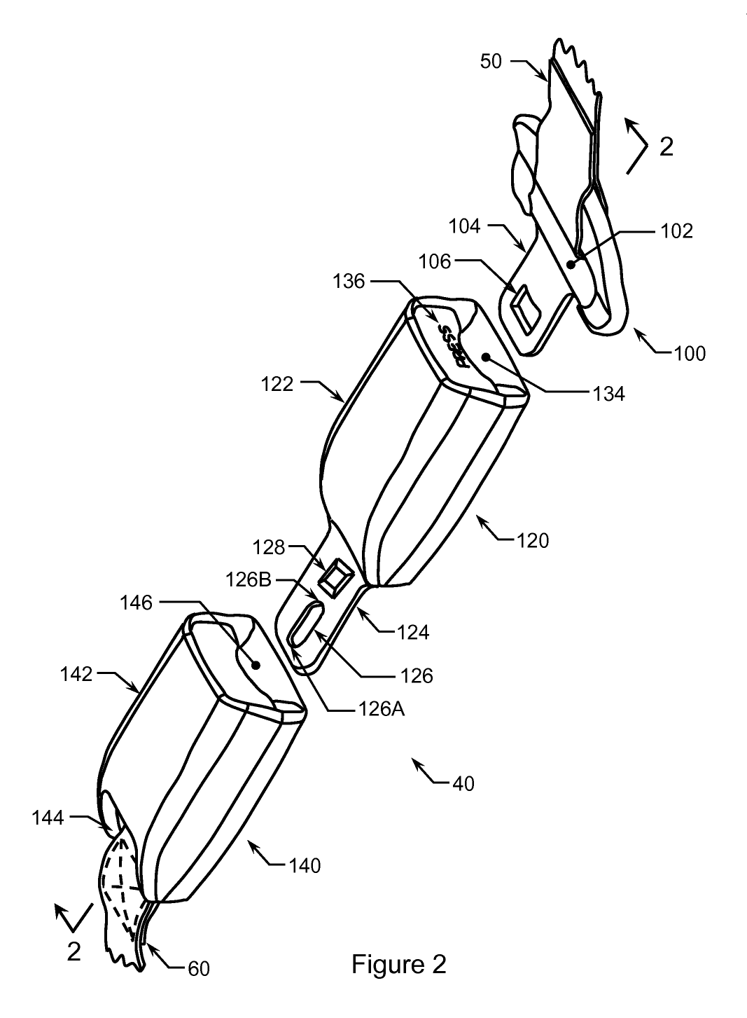

FIG. 3 is an orthographic cross-sectional view of the second buckle assembly of the RLLASA with the RLLASA shown in an unbuckled position;

FIG. 4 is an orthographic cross-sectional view of the second buckle assembly of the RLLASA taken at the location indicated by the section arrows shown in FIG. 2 with the RLLASA shown in a first stage buckle entry position (which is substantially equivalent to a third stage buckle exit position);

FIG. 5 is an orthographic cross-sectional view of the second buckle assembly of the RLLASA taken at the location indicated by the section arrows shown in FIG. 2 with the RLLASA shown in a second stage buckle entry position (which is substantially equivalent to a second stage buckle exit position);

FIG. 6 is an orthographic cross-sectional view of the second buckle assembly of the RLLASA taken at the location indicated by the section arrows shown in FIG. 2 with the RLLASA shown in a third stage buckle entry position (which is substantially equivalent to a first stage buckle exit position);

FIG. 7 is an orthographic cross-sectional view of the second buckle assembly of the RLLASA taken at the location indicated by the section arrows shown in FIG. 2 with the RLLASA shown in a buckle engaged and lock pin disengaged position;

FIG. 8 is an orthographic cross-sectional view of the second buckle assembly of the RLLASA taken at the location indicated by the section arrows shown in FIG. 2 with the RLLASA shown in a buckle engaged and lock pin engaged position, and;

FIG. 9 is an orthographic cross-sectional view of the second buckle assembly of the RLLASA taken at the location indicated by the section arrows shown in FIG. 2 with the RLLASA shown in a limited buckle extended load-limitingly released and lock pin engaged position.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Referring now to the drawings, the invention is a resettable load-limiting adaptive seatbelt apparatus (RLLASA) having the means to readily allow release or disengagement of the seatbelt apparatus at a predetermined load in response to a first situation, and having the means to prevent release or disengagement of the seatbelt apparatus at the predetermined load in response to a second situation, and yet having the means to allow limited non-disengagement load-limiting payout (limited slip) of the seatbelt apparatus at a variable predetermined load in response to a third situation. The first situation may be for instance a subject vehicle non-movement situation or a subject vehicle moving at a rate of less than a predetermined rate such as less than 5 miles per hour situation. Optionally, still subject vehicle predetermined rates such as a 30 mile per hour rate or any rate from 30 miles per hour to 0 miles per hour inclusive are contemplated. The first situation may further optionally be the detection of a pending crash-free situation (of the subject vehicle) or detecting an absence of an oncoming vehicle having a closure rate of more than a predetermined closure rate such as a closure rate of more than 5 miles per hour situation. The first situation may yet further optionally be a combination of a detecting the subject vehicle moving at a rate of less than a predetermined rate and the detection of the absence of an oncoming vehicle having a closure rate of more than a predetermined closure rate.

The second situation may be for instance the subject vehicle moving at a rate of more than a predetermined rate such as more than 5 miles per hour situation. Optionally, still other vehicle predetermined rates such as 1, 2, 3, 8, 10, 13, 15, 18, 20, 22, 15, 30, or any other speed greater than 3 miles per hour rate are contemplated. The second situation may further optionally be the detection of an impending crash situation or detecting an oncoming vehicle having a closure rate of more than a predetermined closure rate such as a closure rate of more than 5 miles per hour situation. The second situation may yet further optionally be either the detection of the subject vehicle moving at a rate of more than a predetermined rate or the detection of an oncoming vehicle having a closure rate of more than a predetermined closure rate.

The third situation may be for instance a crash situation wherein the RLLASA allows the seatbelt to payout or release a predetermined amount (limited slip) but not to disengage while limiting the load applied by the seatbelt to the belted occupant by dissipating a portion of the load that would otherwise be applied to the belted occupant by the limited seatbelt release under load (i.e. energy is dissipated by means of the limited frictional extraction—but not complete disengagement—of the seatbelt). While the load at which seatbelt payout or release but not disengagement occurs under the third scenario is contemplated to be adaptive and higher than the load under which seatbelt payout or release and disengagement occurs under the first scenario, it is possible that there may be some overlap in first scenario and third scenario loads. The third scenario release load may be for instance in the 20 to 750 pound load range.

The first lower load limit may be for instance a 5 pound load limit or other such load limit as would allow a “belted” (having the seatbelt apparatus buckled around a vehicle occupant providing a restraining means for the occupant) vehicle occupant to cause the seatbelt to release simply push out of the seatbelt and yet as would prevent inadvertent seatbelt releases. Further, such first lower load limit may be for instance any wherein from a 1 to a 50 pound load. Or stated differently, by moving from a seated and belted position to an unseated position such as an “exited a vehicle” position, the occupant may cause the seatbelt to release hands-free and with very little effort. The second higher load limit may be for instance a one thousand pound load limit or other such load limit as would allow the RLLASA in a second situation to function in the conventional fashion such as providing a load resisting limitation that may cause failure of an anchor point or of a seat or vehicle frame before the release of the seatbelt. Other possible second higher load limits may include for instance a 5, 10 20, 50, 100, 250, 500 or other load limit.

In order to facilitate the understanding of the present invention in reviewing the drawings accompanying the specification, a feature list is provided below. It is noted that like features are like numbered throughout all of the figures.

FEATURE TABLE

| # | Feature | # | Feature |
|---|---|---|---|
| 10 | Vehicle interior | 20 | Vehicle seat |
| 30 | Vehicle support column | 40 | RLLASA |
| 50 | First belt portion | 60 | Second belt portion |
| 70 | Pulley | 80 | Retractor |
| 90 | First anchor | 92 | Second anchor |
| 100 | First clip | 102 | Belt mounting hole |
| 104 | Tang | 106 | Engagement hole |
| 120 | First buckle assembly | 122 | Housing |
| 124 | Tang | 126 | Lock pin reception slot |
| 126A | Reception slot first end | 126B | Reception slot second end |
| 128 | Knob | 131 | Knob first ramp |
| 133 | Knob second ramp | 135 | Mouth |
| 136 | Eject button | 140 | Second buckle assembly |
| 142 | Housing | 144 | Belt mount |
| 146 | Mouth | 148 | Hinge |
| 150 | First grip plate | 152 | Knob engagement bole |
| 154 | Lock pin reception bole | 160 | Second grip plate |
| 164 | Actuator | 166 | Spring |
| 170 | Solenoid | 172 | Lock pin |

The RLLASA comprises a conventional seatbelt apparatus such as a three-point seatbelt apparatus except that a secondary (female) buckle having a secondary (male) clip is positioned between the primary or convention seatbelt buckle and the anchor point of the seatbelt apparatus (for instance where the seatbelt is fastened to the vehicle floor), and forms a load resisting portion of the seatbelt apparatus such that when the secondary buckle is released (i.e. releases the secondary clip), the seatbelt apparatus is released and such that when the secondary buckle is engaged or buckled (i.e. the secondary clip is engaged in the secondary buckle), the seatbelt apparatus is engaged. The secondary buckle is further adapted such that when the secondary buckle is buckled, the secondary clip may be pulled out of the secondary buckle by applying a first predetermined load such as a load of five pounds or more. This may be accomplished by a variety of different methods. In one embodiment, the secondary clip is sandwiched or frictionally held between two spring loaded grip plates. The force required to withdraw the secondary clip from the grip plates is proportionate to the spring load that is applied to the grip plates, with a lower spring load corresponding to a lower force threshold required to withdraw the clip from the grip plates and a higher spring load corresponding to a higher force threshold required to withdraw the clip from the grip plates. It is contemplated that the RLLASA may be provided such that the clip release load limits may be pre-established by a manufacturer, may be user adjustable, or may be automatically adaptive by for instance varying a pre-load on the springs of the grip plates based on for instance the occupant weight (e.g. higher spring pre-load for a heavier occupant and lower spring pre-load for a lighter occupant) or other various inputs. It is further noted that the preferably adaptive belt release load in a disengageable configuration (e.g. a low or no speed non-crash situation wherein the belted occupant may push out of the belt to disengage the belt) is expected to be in a lower range such as a 1 to a 50 pound load range, than is the preferably adaptive belt release load in a undisengageable configuration (e.g. a high speed crash situation wherein the belted occupant may not push out of the belt to disengage the belt but wherein limited payout of the belt may occur to reduce the peak occupant belt loading that would otherwise occur) which may be for instance in a 20 to a 750 pound load range. The secondary buckle is further adapted to include an electronically actuated solenoid having a locking pin, and the secondary clip is adapted to include a locking pin receiving hole. The secondary buckle is further adapted such that when the solenoid is energized, the locking pin is moved into the locking pin receiving hole and causes the secondary buckle to be held or engaged such that a load of equal to or greater that a second predetermined load, such as a load of one thousand pounds or more, is required to be applied to the RLLASA in order to cause the secondary clip to be released.

More specifically, in a first embodiment of the invention, RLLASA 40 comprises a seatbelt apparatus having a first belt portion 50, a second belt portion 60, a pulley 70, a retractor 80, a first anchor 90, a second anchor 92, a first clip 100, a first buckle assembly 120, and a second buckle assembly 140. Pulley 70 is mounted to a vehicle support column 30, retractor 80 is mounted to a vehicle interior 10, and anchors 90 and 92 are mounted to a vehicle seat 20.

First clip 100 defines a seatbelt clip having a belt mounting hole 102, a tang 104, and an engagement hole 106.

First buckle assembly 120 defines a seatbelt buckle having a housing 122, a tang 124, a mouth 135, and an eject button 136. Tang 124 further includes a lock pin reception slot 126, reception slot first end 126A, reception slot second end 126B, a knob 128, a first knob ramp 131, and a second knob ramp 133. Mouth 134 is formed in a first end of housing 122, and eject button 136 is actuatingly connected to housing 122 and positioned proximate to mouth 134. Tang 124 is mounted to a second end of housing 122.

Second buckle assembly 140 defines a seatbelt buckle having a housing 142, a belt mount 144, a mouth 146, a hinge 148, a first grip plate 150, a second grip plate 160, an actuator 164, a spring 166, a solenoid 170, and a lock pin 172. First grip plate 150 further includes a knob engagement hole 152 and a lock pin reception hole 154. Mouth 146 is formed in a first end of housing 142, and belt mount 144 is connected to a second end of housing 142. First grip plate 150 is connected to a first inner wall of housing 142, and hinge 148, actuator 164, and solenoid 170 are all connected to a second inner wall of housing 142. Spring 166 is connected to actuator 164, and lock pin 172 is extendably and retractably connected to solenoid 170. Second grip plate 160 is connected to hinge 148 on a first end and is positioned next to spring 166 on a second end.

RLLASA 40 is assembled such that a first end of first belt portion 50 is connected to retractor 80, a second end of first belt portion 50 is connected to first anchor 90, and first belt portion 50 is threaded through belt mounting hole 102 of clip 100. First clip 100 is engaged to first buckle assembly 120 by inserting tang 104 of first clip 100 into mouth 134 of first buckle assembly 120. First clip 100 is further disengagable from first buckle assembly 120 by depressing eject button 136. First buckle assembly 120 is engaged to second buckle assembly 140 by inserting tang 124 of first buckle assembly 120 into mouth 146 of second buckle assembly 140. Depending on the (sensed) situation, first buckle assembly 120 is further disengagable from second buckle assembly 140 by merely pulling on or otherwise placing an extraction or disengagement load on first buckle assembly 120 sufficient for first buckle assembly 120 to become disengaged from second buckle assembly 140. Second buckle assembly 140 is connect to second belt portion 160 by a first end of second belt portion 160 being connected to belt mount 144. A second end of second belt portion 160 is connected to second anchor 92. It shall be noted for the purposes of this application that included in the definition of a “disengagement load” shall be a load—typically applied in tension—that is placed on a seatbelt apparatus such that the seatbelt apparatus becomes disengaged in direct response to the loading in a non-destructive and typically re-engageable manner if the seatbelt apparatus is in a disengageable mode and if the disengagement load is of a sufficient magnitude to cause disengagement. It shall be further noted for the purposes of this application that a “disengagement load” defines over and is distinguished from a load placed on an eject button or the like to cause a seatbelt apparatus to disengage.

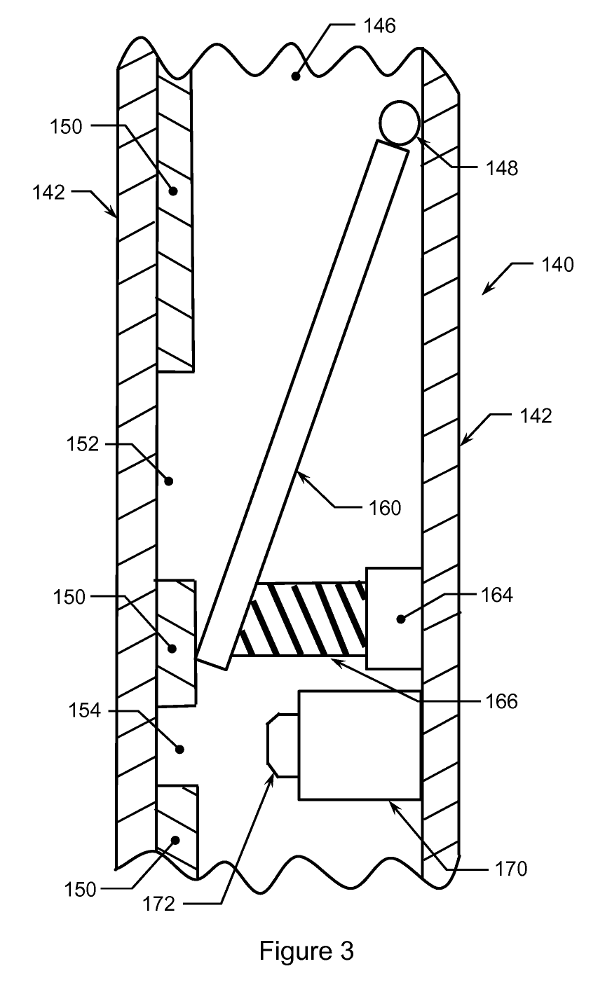

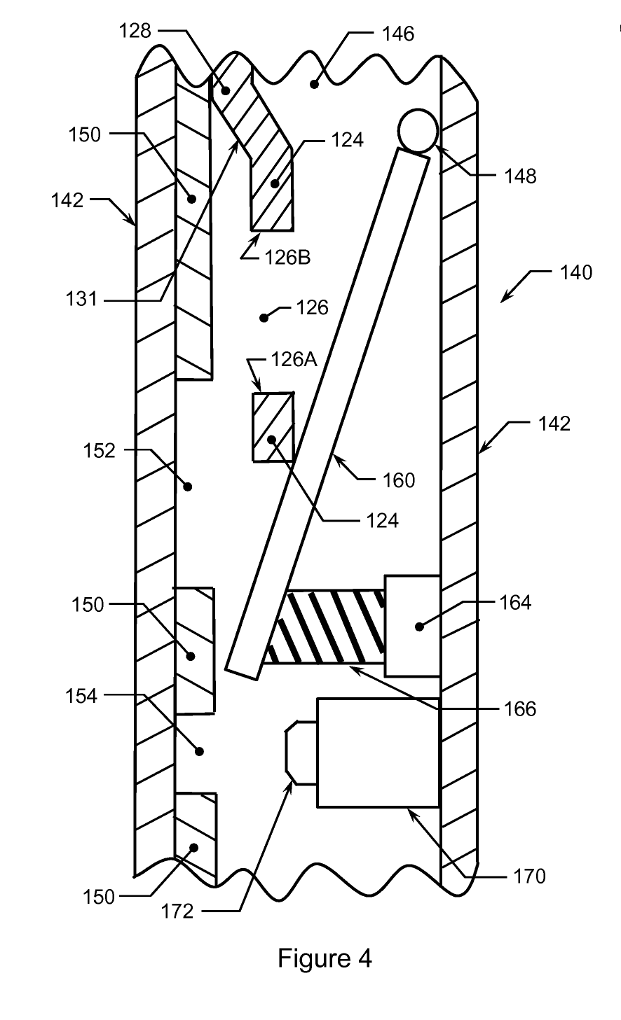

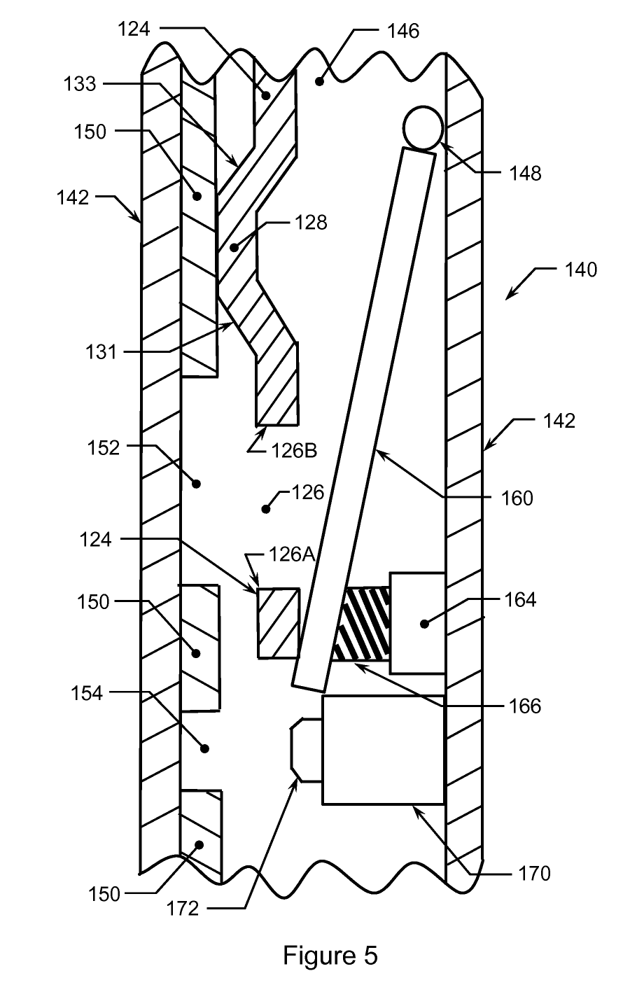

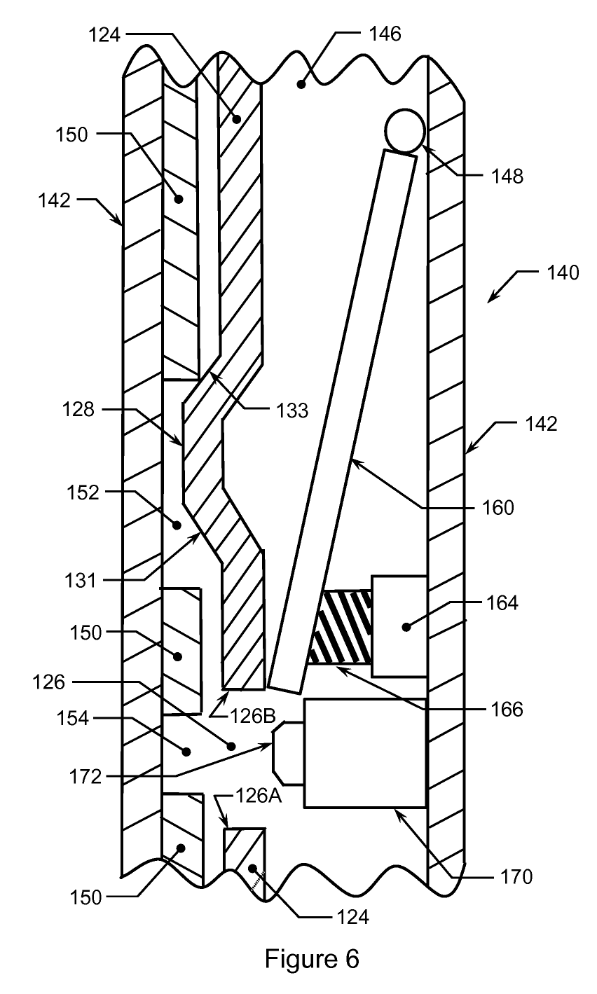

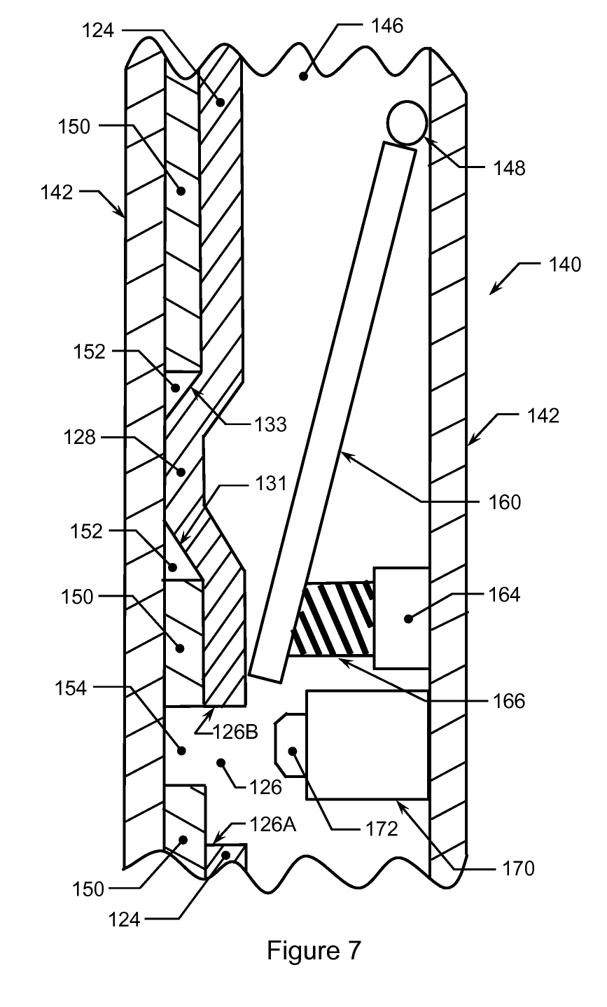

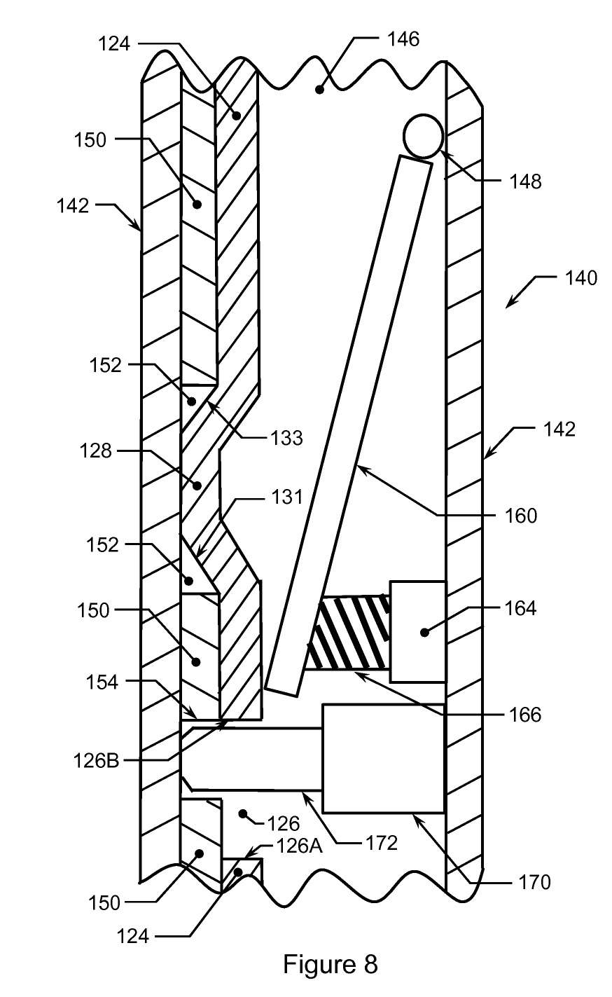

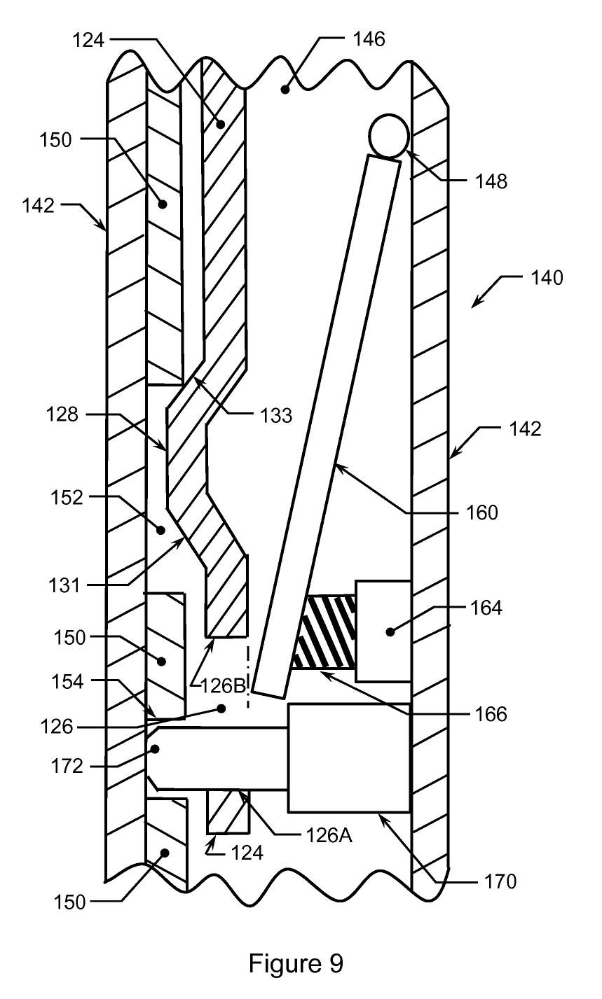

To further illustrate the function of RLLASA 40, reference is made to FIGS. 3 through 8. FIG. 3 depicts a cross-sectional view of second buckle assembly 140 without tang 124 of first buckle assembly 120 being inserted into buckle assembly 140 (e.g. pre-insertion or post-extraction of tang 124). Second grip plate 160 is shown spring loadedly positioned against first grip plate 150 by means of spring 166 pushing against second grip plate 160 and lock pin 172 is shown in a retracted (unlocked) position. Actuator 164 functions to apply a greater or lesser compressive load on spring 164, with such compressive load preferably corresponding to a sensed condition. Thus for instance, if a larger or heavier occupant is sensed, a greater compressive load is applied to spring 166 resulting in a greater force required to cause second grip plate 160 to be moved away from first grip plate 150. Conversely for instance, if a smaller or lighter occupant is sensed, a lesser compressive load is applied to spring 166 resulting in a lesser force required to cause second grip plate 160 to be moved away from first grip plate 150. FIG. 4 depicts a cross-sectional view of second buckle assembly 140 with tang 124 of first buckle assembly 120 being in a first stage of insertion into buckle assembly 140 (pictorially substantially equivalent to a third stage of extraction of tang 124 from buckle assembly 140). Second grip plate 160 is shown slightly “opened” from first grip plate 150 by tang 124, spring 166 is shown somewhat more compressed than in FIG. 3, and lock pin 172 is shown in a retracted (unlocked) position. FIG. 5 depicts a cross-sectional view of second buckle assembly 140 with tang 124 of first buckle assembly 120 being in a second stage of insertion into buckle assembly 140 (pictorially substantially equivalent to a second stage of extraction of tang 124 from buckle assembly 140). Second grip plate 160 is shown “opened” further from first grip plate 150 by tang 124 than it was in FIG. 4, spring 166 is shown further compressed than in FIG. 4, and lock pin 172 is shown in a refracted (unlocked) position. FIG. 6 depicts a cross-sectional view of second buckle assembly 140 with tang 124 of first buckle assembly 120 being in a third stage of insertion into buckle assembly 140 (pictorially substantially equivalent to a first stage of extraction of tang 124 from buckle assembly 140). Second grip plate 160 is shown “opened” an intermediate amount from first grip plate 150 by tang 124, spring 166 is shown compressed an intermediate amount, knob 128 is shown beginning to be positioned into knob engagement hole 152 by knob second ramp 133 sliding against the corner of engagement hole 152 (pictorially substantially equivalent to knob 128 is beginning to be extracted from knob engagement hole 152 by knob second ramp 133 sliding against the corner of engagement hole 152), and lock pin 172 is shown in a retracted (unlocked) position. FIG. 7 depicts a cross-sectional view of second buckle assembly 140 with tang 124 of first buckle assembly 120 fully inserted into second buckle assembly 140 by knob 128 being seated into engagement hole 152. Second grip plate 160 is shown securingly pressed against tang 124, spring 166 is shown compressed an intermediate amount, and lock pin 172 is shown in a retracted position. With RLLASA 40 thus assembled, but with lock pin 172 in a retracted (unlocked) position, the application of a predetermined extraction load to first buckle assembly 120 will cause knob second ramp 133 to “ride up” the edge of knob engagement hole 152, knob 128 to become dislodged from knob engagement hole 152, second grip plate 160 to move away from first grip plate 150, spring 166 to be further compressed, and first buckle assembly 120 to be extracted from second buckle assembly 140. FIG. 8 depicts a cross-sectional view of second buckle assembly 140 with tang 124 of first buckle assembly 120 fully inserted into second buckle assembly 140 by knob 128 being seated into engagement hole 152. Second grip plate 160 is shown securingly pressed against tang 124, spring 166 is shown compressed an intermediate amount, and lock pin 172 is shown in an extended (locked) position. Lock pin 172 is extended preferably corresponding to a sensed condition such as a vehicle moving faster than a predetermined amount condition or an impending crash condition. With lock pin 172 extended, lock pin 172 is engaged into lock pin reception slot 126 of tang 124 near slot first end 126A and engaged into lock pin reception hole 154 of first grip plate 150. With lock pin 172 thus extended, first buckle assembly 120 is prevented from being completely extracted from second buckle assembly 140 due to potential interference of lock pin 172 with slot second end 126B. FIG. 9 depicts a cross-sectional view of second buckle assembly 140 with tang 124 of first buckle assembly 120 being in a stage of post-load-limiting extraction from buckle assembly 140. Second grip plate 160 is shown “opened” an intermediate amount from first grip plate 150 by tang 124, spring 166 is shown compressed an intermediate amount, knob 128 is shown beginning to be positioned out of knob engagement hole 152 by knob second ramp 133 sliding against the corner of engagement hole 152, and lock pin 172 is shown in an extend (locked) position and is retained by interface with slot second end 126B.

The invention contemplates that a vehicle in which the RLLASA 40 is installed will include sensors and a CPU such as are common in the art such that in combination the vehicle will have the means to detection vehicle speed, oncoming vehicle speed, occupant presence, occupant weight, etc., and communicate such information as needed to appropriately actuate RLLASA 40 in the manner described above. Exemplary inventions relating to occupant sensing, collision sensing, and automotive safety systems included the concepts disclosed in the following US patents and applications and research disclosure which are incorporated herein by reference in their entirety: U.S. Pat. No. 5,482,314 to Corrado et al entitled “Automotive Occupant Sensor System and Method of Operation by Sensor Fusion”, U.S. Pat. No. 6,272,411 to Corrado et al entitled “Method of Operating a Vehicle Occupancy State Sensor System”, U.S. Pat. No. 6,283,504 to Stanley et al entitled “Occupant Sensor”, U.S. Pat. No. 6,497,431 to Schramm entitled “Adaptive Restraint System”, U.S. Pat. No. 6,577,023 to Stanley et al entitled “Occupant Detection System”, U.S. Pat. No. 6,598,900 to Stanley et al entitled “Occupant Detection System”, U.S. Pat. No. 7,413,049 to Schramm et al entitled “Pedestrian Protection Hood Lifting Systems”, 2003/0149530 to Stopczynski entitled “Release Collision Warning and Safety Countermeasure System”, and research disclosure 484045 to Schramm entitled “Improved Pedestrian Protection Hood Lifting Apparatus”. It is further contemplated that RLLASA 40 may be provided with and used in combination with seatbelt “pretensioning”. It is also noted that in an alternate embodiment, the functions of the secondary buckle may be integrated into a single modified primary buckle. It is also noted that in yet a further alternate embodiment, a buckle having the described functions of the secondary buckle may be located at a different location on the RLLASA 40 such as near an anchor mount point end of the RLLASA 40. It is also noted that in yet a further alternate embodiment, RLLASA 40 may be retroactively installed in a vehicle. It is further noted that actuator 164 or solenoid 170 or both may optionally be replaced with an active material and more preferably by a two-way “active material” such as a shape memory alloy (SMA). Exemplary inventions relating to “active materials” included the concepts disclosed in US patent application 20090302588 to Schramm entitled “Systems and Methods for Airbag Tether Release”, and U.S. Pat. No. 8,205,631 to Schramm et al entitled “Active Material Actuated Vent Valve”. US patent application 20090302588 and U.S. Pat. No. 8,205,631, and the applications and the patents which are cited therein are all incorporated herein by reference in their entirety. It is further contemplated that RLLASA 40 may be used in combination with a warning or indication such as an indicia or sound. It is noted that there exists a substantially universally recognized seatbelt indication symbol typically comprising a constant red (LED) lighted image of a person seated in a vehicle seat and having a seatbelt restraining the person (hereinafter seatbelt symbol). In a vehicle incorporating RLLASA 40, the vehicle could for instance display: a flashing red seatbelt symbol when RLLASA 40 is unbuckled, a steady yellow/amber seatbelt symbol when RLLASA 40 is buckled but releasable in response to a predetermined load (e.g. RLLASA 40 in the unlocked position), and a steady temporary green seatbelt symbol when RLLASA 40 is buckled and not releasable in response to the predetermined load (e.g. RLLASA 40 in the locked position). Other combinations of colors, steady versus blinking, and temporary versus non-temporary seatbelt symbols are also contemplated. Furthermore, it is contemplated that tang 124 may be a red colored tang such that it is rendered obvious when tang 124 is in the position depicted in FIG. 9.

Having described RLLASA 40, it is pointed out that in practice, usage of RLLASA 40 is very similar to the use of a conventional seatbelt. Thus for instance, if a buckled occupant desires to leave the vehicle, RLLASA 40 is unbuckled in the conventional fashion and the occupant leaves the vehicle. Thus further for instance, if a buckled occupant needs to rapidly leave the vehicle (e.g. the occupant is in a police emergency), or if a buckled occupant cannot reach the primary buckle eject button or is unable to depress the eject button (e.g. the occupant is in a crash such as in a water landing, the occupant's hand or arm has become disabled due to the crash, the load on the belt has caused the eject button to bind, or the operator has become panicked), and if the first situation is encountered, the load of the occupant merely attempting to leave the vehicle without touching the primary buckle eject button will cause RLLASA 40 to release with minimal effort and force or in the case of an operator releasing a child from a seatbelt, the operator merely pulls on the seatbelt. Thus further for instance, if a buckled post-crash unconscious occupant is found, an emergency responder may merely apply a simple tugging motion and load to RLLASA 40 to release RLLASA 40 (assuming the first situation). Such release method is especially helpful in a situation where the (especially conventional) seatbelt is jammed or inaccessible. It is further noted that if second buckle assembly 140 is unbuckled and a user is ready to again use RLLASA 40, second buckle assembly 140 may be re-buckled much the same as a primary seatbelt buckle is re-buckled. It is yet further noted that the invention is also particularly useful for a user such as a law enforcement officer, who vacillates between low speed patrolling with a preference for a conventional seatbelt to be unbuckled and higher speed patrolling with a preference for a seatbelt to be buckled (but possibly not being able to take the time to buckle up). Once buckled, RLLASA 40 effectively provides the benefit of both a low speed unbuckled scenario and a higher speed buckled scenario, all without ever having to touch a seatbelt buckle or button. Thus further for instance, if a third (crash) situation is encountered, RLLASA 40 allows for a limited amount of seatbelt payout by releasing tang 124 by the amount of the length of slot 126 while under an adaptively variable peak load-mitigating resistance force or load. It is contemplated that for a given occupant, the load required to cause RLLASA 40 to release and completely disengage in a first situation (e.g. a non-crash scenario) will be much lower than the load required to cause RLLASA 40 to release a limited amount but not disengage in a third situation (e.g. a load-limiting crash scenario).

In summary, RLLASA 40 provides the proper amount of seatbelt restraint ability matched or adapted to a given situation. The invention functions to automatically switch back and forth from a low-load break-away seatbelt at low speed (or no speed) to a conventionally functioning seatbelt at higher speeds, and further to a resettable load-limiting seatbelt in a crash situation. Usage of RLLASA 40 is for the most part substantially “transparent” to the user. Or in other words, to the user, RLLASA 40 in practice is substantially similar to a conventional seatbelt apparatus. If the user never needs to make an emergency exit from the vehicle, the user may not even appreciate or be aware of the functioning and added safety of RLLASA 40. Moreover, in a post-crash scenario wherein RLLASA 40 has load-limitingly released a limited (not disengaged) amount, tang 124 merely needs to be pushed back into place to reset RLLASA 40.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A seatbelt apparatus having a limited non-disengagement crash-load-limiting payout slip (limited slip) belt engagement device, wherein the threshold of resistance to slip of said apparatus varies.

2. The apparatus of claim 1, wherein said limited slip occurs in response to an adaptively variable load.

3. The apparatus of claim 1, wherein said threshold of resistance to slip adaptively varies in response to at least one of vehicle speed, occupant mass, and vehicle crush resistance.

4. The apparatus of claim 1, wherein said limited slip defines a peak belt load mitigating slip.

5. The apparatus of claim 1, wherein said limited slip defines at least a partial slip of a belt male connection member from a belt female connection member.

6. The apparatus of claim 1, wherein said limited slip occurs in response to a crash.

7. The apparatus of claim 1, wherein said apparatus is adapted such that in a first scenario said apparatus allows limited release of a seatbelt in response to a seatbelt tension disengagement load, and wherein in a second scenario said apparatus allows complete release of a seatbelt in response to a hands-free seatbelt tension disengagement load.

8. The apparatus of claim 7, wherein a load required to cause said limited slip in said first scenario is greater than the load required to cause complete release of said seatbelt in said second scenario.

9. The apparatus of claim 8, wherein said load of said first scenario defines a load in the range of 20 to 750 pounds, and wherein said load of said second scenario defines a load in the range of 1 to 200 pounds.

10. A seatbelt apparatus adapted such that in a first scenario said apparatus allows limited non-disengagement crash-load-limiting payout release (limited release) of a seatbelt in response to a seatbelt tension disengagement load, and wherein in a second scenario said apparatus allows complete release (complete disconnection) of a seatbelt in response to a hands-free seatbelt tension disengagement load, wherein the threshold of resistance to release of said seatbelt varies.

11. The apparatus of claim 10, wherein said limited release defines a limited slip of a limited slip belt engagement device.

12. The apparatus of claim 10, wherein said limited release of a seatbelt occurs in response to an adaptively variable load.

13. The apparatus of claim 10, wherein said threshold of resistance to release of said seatbelt adaptively varies in response to at least one of vehicle speed, occupant mass, and vehicle crush resistance.

14. The apparatus of claim 10, wherein said limited release of a seatbelt defines a peak belt load mitigating limited release.

15. The apparatus of claim 10, wherein said limited release of a seatbelt defines at least a partial release of a first belt connection member from a second belt connection member.

16. The apparatus of claim 15, wherein said first belt connection member defines a belt male connection member and wherein said second belt connection member defines a belt female connection member.

17. The apparatus of claim 10, wherein said limited release of a seatbelt occurs in response to a crash.

18. The apparatus of claim 10, wherein a load required to cause said limited release of a seatbelt in said first scenario is greater than the load required to cause complete release of said seatbelt in said second scenario.

19. The apparatus of claim 18, wherein said load of said first scenario defines a load in the range of 20 to 750 pounds, and wherein said load of said second scenario defines a load in the range of 1 to 200 pounds.

20. A seatbelt apparatus that disengages in response to a hands-free seatbelt tension disengagement load.
